(19) United States
(12) Patent Application Publication
(10) Pub. No.: US 2015/0324199 A1
(43) Pub. Date: Nov. 12, 2015

(54) COMPUTER PROCESSOR AND SYSTEM WITHOUT AN ARITHMETIC AND LOGIC UNIT

(71) Applicant: KONINKLIJKE PHILIPS N.V., EINDHOVEN (NL)

(72) Inventors: Mina DENG, SHANGHAI (CN); Paulus Mathias Hubertus Mechtildis Antonius GORISSEN, EINDHOVEN (NL); Ludovicus Marinus Gerardus Maria TOLHUIZEN, WAALRE (NL); Arnoldus Jeroen NIESSEN, HEEZE (NL)

(21) Appl. No.: 14/410,127

(22) PCT Filed: Jul. 6, 2013
(86) PCT No.: PCT/IB2013/055541

§ 371 Date: Dec. 22, 2014

Related U.S. Application Data
(60) Provisional application No. 61/668,482, filed on Jul. 6, 2012.

(30) Foreign Application Priority Data
Feb. 27, 2013 (EP) 13156975.8

(51) Int. Cl. G06F 9/30

(52) U.S. Cl. CPC G06F 9/30145; G06F 9/3001; G06F 9/30029

(57) ABSTRACT

A computer system comprising a processor and a memory, the processor comprising an instruction cycle circuit configured to repeatedly obtain a next instruction of a computer program, an instruction decoder configured to decode and execute the instruction obtained by the instruction cycle circuit, the computer system supporting multiple arithmetic and/or logic operations under control of one or more of the instructions, wherein the memory stores multiple tables, each specific one of the multiple arithmetic and/or logic operations being supported by a specific table stored in the memory, each specific table comprising the result of the specific arithmetic operations for a range of inputs.

### FIELD OF THE INVENTION

The invention relates to a computer system comprising a processor and a memory.

### BACKGROUND OF THE INVENTION

It has long been known that computer systems leak some information through so-called side-channels. Observing the input-output behavior of a computer system may not provide any useful information on sensitive information, such as secret keys used by the computer system. But a computer system has other channels that may be observed, e.g., its power consumption or electromagnetic radiation; these channels are referred to as side channels.

Through a side channel a computer system may ‘leak’ secret information during its use. Observing and analyzing a side channel may give an attacker access to better information than may be obtained from the input-output behavior.

Current approaches to the side channel problem try to introduce randomness in the computation. These have proved less than satisfactory. They complicate the computation and use additional power. Moreover, countermeasures based on randomness may often be reversed using statistical means.

### SUMMARY OF THE INVENTION

It was an insight of the inventor that the various different elements of a computer system do not contribute to the side channel in the same way. In particular the energy consumption of an ALU depends directly on the data it processes. In particular if an ALU processes secret information its contribution to the power consumption is dependent upon secret information. The power consumption of other elements of a computer are much less depended on the actual data value.

It would be advantageous to have an improved computer system for which the power consumption is less dependent upon the secret data.

A computer system is provided comprising a processor and a memory, the processor comprising an instruction cycle circuit configured to repeatedly obtain a next instruction of a computer program, an instruction decoder configured to decode and execute the instruction obtained by the instruction cycle circuit, the computer system supporting multiple arithmetic and/or logic operations under control of one or more of the instructions, wherein the memory stores multiple tables, each specific one of the multiple arithmetic and/or logic operations being supported by at least one specific table stored in the memory that represents at least part of the result of the specific arithmetic operations for a range of inputs.

By eliminating the ALU from the system, all its contribution to side-channels is also eliminated. This makes the system more resilient against side-channel attacks.

The computer system provides a hardware solution to facilitate table-driven programs or virtual machines. The computer system allows any order of table accesses. Using the computer system secure virtual machines may be implemented. Note that, as in white-box cryptography, tables implementing instructions may be obfuscated, so that the functionality of tables cannot be reversed-engineered; however obfuscation need not necessarily be applied.

The computer system provides many more advantages, some of which are listed below:

Simplified processor design: there is no need for a complex connection (bus) between register files and ALUs,

Free choice of instruction set. The semantics of an operation is in a table. The table can be filled with simple, complex, or, encrypted operations.

Extendable instruction set. New tables can be added in memory during the execution of other programs.

Electrically all operations are table accesses, therefore the operations in the table have a similar electrical behavior. As a result, reverse-engineering of a program by employing differences of electrical behaviors of different operations is infeasible.

Reduced BoM because of absence of ALUs,

Improved power efficiency.

Fast execution by efficient pipelining,

Increased resilience against temporary power shortage (as can occur in Near Field Communications (NFC). This is so as intermediate processing states are kept in memory and the processing can be resumed when energy is available again,

Enhanced security: cryptographic attacks that exploit properties of the ALU (known as side-channel attacks) are infeasible as no ALU is present. Moreover, the tables replacing the ALU operations can be in an encrypted domain, that is, indexes are encrypted and/or table value too.

The ALU-free table-driven processor is ideal for applications where energy consumption, speed and security are important. The computer system may be applied in NFC.

Various embodiments of an ALU-free table-driven processor are provided, with which operations performed in the ALU with conventional processors, are performed as table accesses in memory. The tables on the processor can contain expensive sub-computations but they are computed beforehand.

For example, the memory may store multiple tables, so that each specific one of the multiple arithmetic and/or logic operations is supported by a specific table stored in the memory, each specific table comprising the result of the specific arithmetic operations for a range of inputs. Having the result of an operation in memory has the advantage that fewer table look-ups are needed. On the other hand by splitting an operation over multiple tables, the sizes of the tables are smaller. For example, one or more or all of the arithmetic and/or logic instructions may be supported by multiple tables stored in the memory, so that the multiple tables together represent the result of the specific arithmetic operations for a range of inputs.

For example, sub-multiplication tables may be used to reduce the lookup table size of a multiplication table.

In an embodiment, the processor comprises a table translator, the table translator is configured to receive arithmetic and/or logic instruction from an instruction register and to produce corresponding table look-up operations. For example, the table translator may be connected to an internal bus of the processor. The table translator may use microprograms to execute the instruction. The table translator may be comprised in an instruction decoder.

In an embodiment, the computer system has a stand-by device configured to save the content of registers of the processor, including instruction pointer. The computer system according to the invention is particularly efficient for stand-by operation since no content of an ALU needs to be saved. The instruction pointer may be implemented as an instruction pointer register.

In an embodiment, arithmetic and/or logic operations are exclusively supported by look-up tables. In an embodiment, the computer system does not comprise a combination logic circuit receiving a first and second operand from an internal bus of the processor and producing an output to the internal bus calculated from the first and second operand.

In an embodiment, the instruction decoder is configured for jumps conditional on a conditional value by, retrieving a data item representing an address from a table at a location in the table corresponding to the conditional value, and writing the address to an instruction pointer. For example, the instruction decoder may comprise a data item retriever for retrieving the data item and an address writer for writing the address to an instruction pointer. The data item may be the absolute address itself. The data item may be an offset relative to the current address stored in the instruction pointer. In this way conditional jumps may be implemented without the need of a status register.

In an embodiment the instruction cycle circuit comprises microinstructions, e.g., using table-look-up from tables stored in a memory comprised in the instruction cycle circuit. In an embodiment, lookup tables supporting instructions and the look-up tables supporting the instruction cycle circuit are in the same memory. Even the microcode may be stored in the memory. Such an instruction cycle circuit would be even simpler to implement.

In an embodiment, the memory has a memory architecture that incorporates table handling. This has the advantage of alleviating the bandwidth-limited connection between memory and processor and allowing tight high-bandwidth integration.

In an embodiment, the computer system has an address calculation unit for computing the address of an entry in a table from a base address and an index, wherein the address calculation unit concatenates the base address and the index.

In embodiment, the memory comprises an instruction type table, the instruction type table storing the base address of all tables supporting the arithmetic and logic functions.

In an embodiment, the arithmetic and/or logic operations are supported by retrieving, e.g., from the instruction type table, e.g., by a retriever, the base address of the tables supporting said arithmetic and/or logic operation, adding, e.g., by an adder, to the base address an in index obtained from a first operand to said arithmetic and/or logic operation, and retrieving from the added base address a result or a further table address. Note that the adder may concatenate the base address and the index instead of regular adding.

A further aspect of the invention concerns a computer processor as in the computer system.

A further aspect of the invention concerns a compiler configured to compile a computer program in a first computer language for a computer system as in any one of the preceding claims. For example, a regular compiler for a processor having an ALU may be used, which is modified to translate all arithmetic and logic opcodes to table-lookup operations.

The compiler may also compile the needed look-up tables, by computing the result of an arithmetic or logic operation for a range of input values and storing the result in a table. Non-volatile memory for the memory having look-up tables is preferred.

The look-up tables may also be present in a ROM in the processor.

The computer system is an electronic device, in particular a mobile electronic device, e.g., mobile phone, set-top box, computer, etc. The computer system may be a smart card.

A computer system is provided having a processor and a memory. The processor comprises a usual instruction cycle circuit to repeatedly transfer a next instruction from the memory to an instruction register. The transferred instruction is decoded and executed with an instruction decoder. The computer system supports multiple arithmetic and logic operations, such as addition, multiplication, etc, which may be executed under control of the instructions. Surprisingly, the memory stores multiple tables; each specific one of the multiple operations is supported by the multiple tables stored in the memory. The tables may contain the result of the specific operation for a range of inputs. In particular the multiple arithmetic operations may be supported exclusively by multiple tables, so that the processor does not need an ALU. The advantage is a less complicated, more secure processor.

### BRIEF DESCRIPTION OF THE DRAWINGS

These and other aspects of the invention are apparent from and will be elucidated with reference to the embodiments described hereinafter. In the drawings,

FIG. 1 shows an ALU in a conventional computer processor,

FIG. 2 shows a computer system having a processor without an ALU,

FIG. 3a shows a first instruction cycle circuit,

FIG. 3b shows a second instruction cycle circuit,

FIG. 4 illustrates table based arithmetic,

FIGS. 5 and 6 illustrate execution of a table based program,

FIG. 7 illustrates execution of a table based program using a table control register,

FIG. 8 illustrates carry-less address computation for tables,

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED EMBODIMENTS

While this invention is susceptible of embodiments in many different forms, there is shown in the drawings and will herein be described in detail one or more specific embodiments, with the understanding that the present disclosure is to be considered as exemplary of the principles of the invention and not intended to limit the invention to the specific embodiments shown and described.

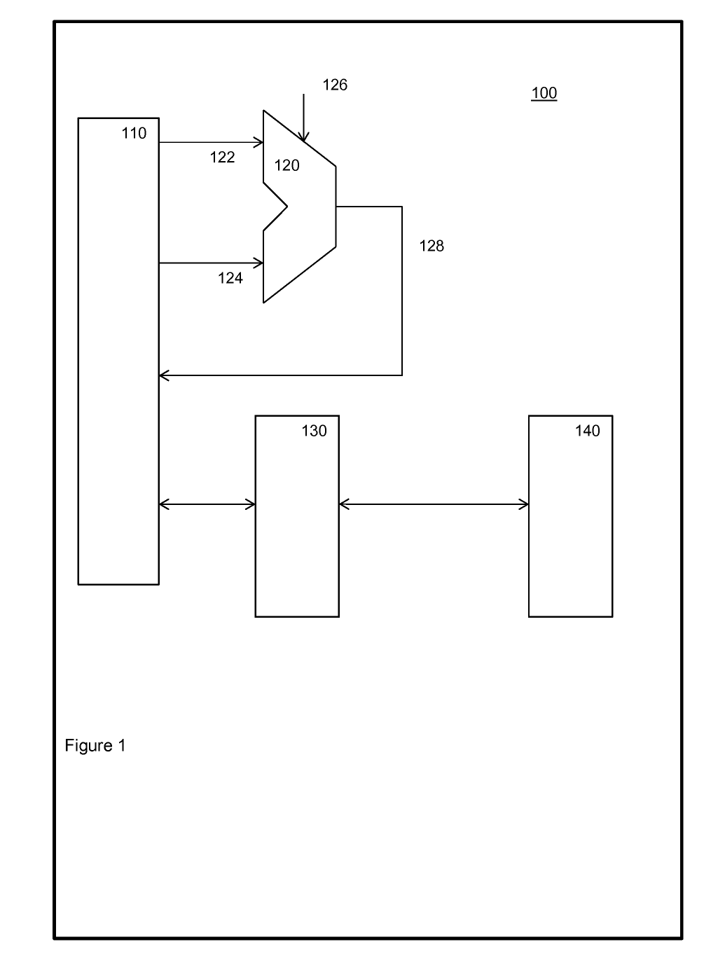

FIG. 1 shows a conventional processor 100 comprising an ALU 120. For example, ALU 120 is a 32 bit ALU. In computing, an ALU (Arithmetic Logic Unit) is a digital circuit that performs arithmetic and logical operations. The ALU is a fundamental building block of the central processing unit of a computer, and even the simplest microprocessors contain one or more ALUs. Most of a processor's operations are performed by one or more ALUs. An ALU loads data from input registers, an external Control Unit then tells the ALU what operation to perform on that data, and then the ALU stores its result into an output register. The Control Unit is responsible for moving the processed data between these registers, ALU and memory. For example, the ALU may use a multiplexor to select the output corresponding to the operation.

ALU 120 is implemented as combinational logic (sometimes also referred to as combinatorial logic) which is a type of digital logic which is implemented by Boolean circuits, where the output is a pure function of the present input only. Combinational logic has no memory to carry results from one operation to the next.

FIG. 1 shows an internal bus 110 and an ALU 120. ALU 120 receives inputs 122 and 124 from internal bus 110, and provides an output 128 to the internal bus. The operation performed by ALU 120 is under the control of ALU control signal 126. Processor 100 may comprise other circuitry, e.g., an instruction cycle circuit, address calculating unit, etc, which is schematically indicated with computer processor circuitry 130. Processor 100 may be connected to a memory 140.

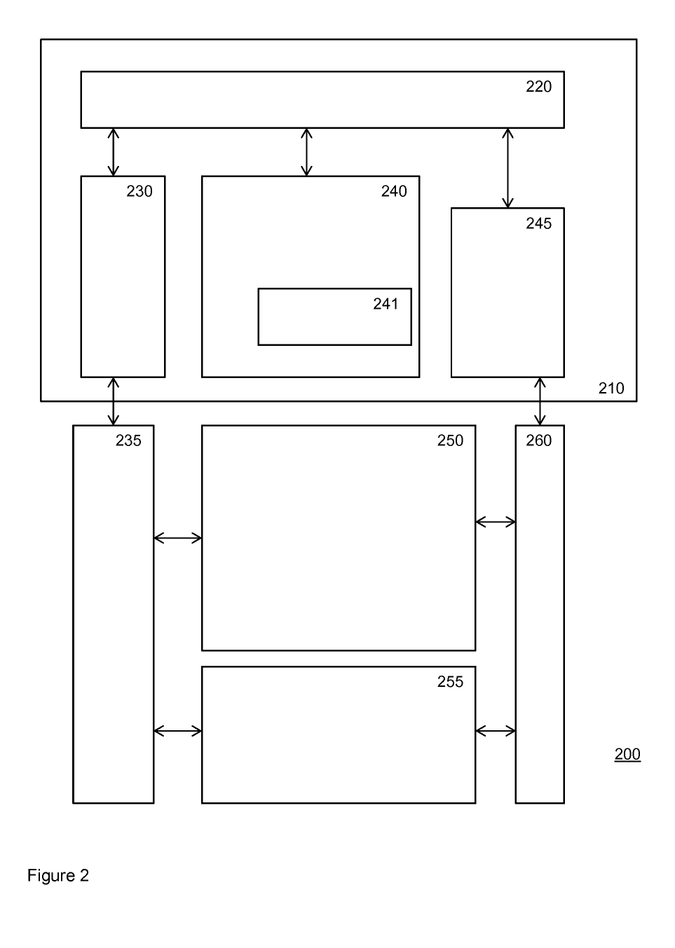

FIG. 2 shows a computer system 200. Computer system 200 comprises a computer processor 210, e.g. a CPU. System 200, in particular processor 210, does not comprise an ALU. Arithmetic and logic operations are implemented using look-up tables as described herein.

Apart from the processor the system may have additional components. Shown in FIG. 2, within system 200 but external to processor 210, is a memory 250, a memory mapped I/O interface 255, a data and address bus 235 and a control bus 260. Memory mapped I/O interface 255 is optional; other ways of I/O interface may be used. Memory 250 may be integrated in processor 210 instead of having it external. Processor 210 may have an address calculating unit (ACU) comprising interface 230.

Processor 210 comprises an internal bus 220, a data and address bus interface 230, an instruction cycle circuit 240, instruction decoder 241 and a register file 245.

Processor 210 may retrieve data from memory 250 via data and address bus interface 230. Typically a data and address bus 235 are executed as a separate data bus and address bus. An address is put on the address bus using interface 230, in response memory 250 retrieves the data content of the memory location with that address. Through interface 230, the retrieved data is put on internal bus 220. Memory or I/O exceptions or faults etc may be put on control bus 260, which writes to a register of register file 245. If no exceptions etc are desired, or are communicated in a different way, bus 260 may be omitted.

Register file 245 comprises multiple registers. For example, the registers may be 8 bit wide. For example, processor 210 may have three registers, X, Y and Z in register file 245. For example, processor 210 may have more registers, e.g. 8, 12, 16, 32, or more.

Instruction decoder 241 is shown as comprised in Instruction cycle circuit 240, but this is not necessary. The two circuits may be implemented apart and communicate via, e.g. internal bus 220 or via an additional internal bus, etc.

Instruction cycle circuit 240 is configured to repeatedly obtain a next instruction of a computer program. The computer program may be stored in memory 250, or come from another source, e.g., a cache, an external source etc. For example, the instruction cycle circuit 240 may comprise a program counter register, the instruction cycle circuit being configured to obtain the next instruction under control of the program counter register. For example, the instruction cycle circuit 240 may transfer an instruction from memory 250 at a memory address indicated by the program counter register to an instruction register. The instruction decoder 241 has access to the instruction register.

The instruction cycle circuit may comprise a program counter register advancer (not shown in FIG. 2) configured to advance the program counter register so that the program counter register controls the obtaining of a next instruction. The program counter register advancer may modify the program counter register so that it contains the address in memory of a next instruction. In particular the program counter register advancer may increase the program counter register with the instruction width in bytes.

Processor 210, e.g. instruction cycle circuit 240, comprises an instruction decoder configured to decode and execute the instruction obtained by instruction cycle circuit 240.

Processor 210 may comprise an addressing unit (not shown) for retrieving data from tables stored in the memory, the addressing unit may comprise the data and address bus interface 230 connecting the processor to the data and address bus. The addressing unit may be configured to compute an address from a base address and an index. The addressing unit is also referred to as an address calculating unit (ACU). The computation of table, e.g. array, addresses may be optimized, as described herein, by choosing the base address as a multiple of a power of a two.

For example, processor 210 may go through multiple instruction cycles. An instruction cycle may begin with a fetch, in which the instruction cycle circuit 240 places the value of program counter on the address bus to send it to the memory. The memory responds by sending the contents of that memory location on the data bus. Following the fetch, processor 210 proceeds to execution, taking some action based on the memory contents that it obtained. At some point in this cycle, the program counter will be modified so that the next instruction executed is a different one. For example, it is incremented so that the next instruction is the one at the next sequential memory address. Like other processor registers, program counter may be a bank of binary latches, each one representing one bit of the value of program counter.

In one embodiment, processor 210 has, apart from the addressing unit, memory and registers, (micro-)program logic to go along with the instruction pointer. The instruction execution of processor 210 may use so-called micro-programs. For example, instruction decoder 241 may comprise a micro-programmed control unit, the control signals that are to be generated at a given time step are stored together in a control word, i.e., a so-called microinstruction. The collection of control words that implement an instruction is called a microprogram, and the microprograms are stored in a memory element called the control store.

However, processor 210 does not need to comprise a micro-program, or even an instruction pointer. Instead instructions may be pre-determined and stored in the hardware. Furthermore, control signal logic expressions may also be directly implemented with logic gates or in a programmed logic array (PLA).

Processor 210 shows an approach for implementing a table-driven processor in hardware. The table driven-implementation does not comprise an ALU, but may comprise an ACU (address calculating unit). A table-driven computer program is a network of lookup tables. A program is translated into a network of tables, implemented as a chain (sequence) of table accesses.

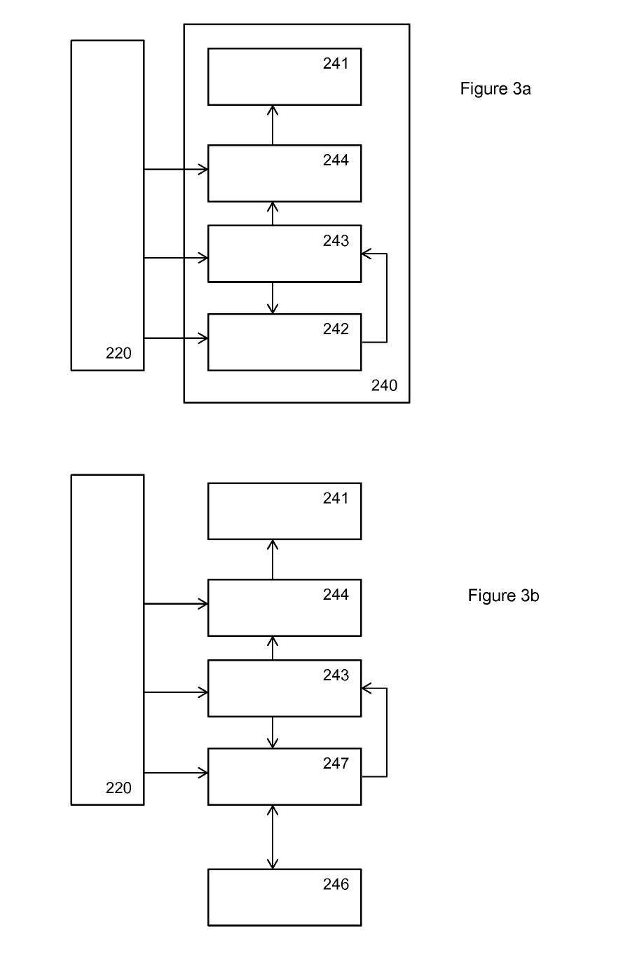

FIGS. 3a and 3b illustrate two different implementations of instruction cycle circuit 240 that may be used in processor 210.

FIG. 3a shows an instruction cycle circuit comprising an instruction decoder 241, an adder 242, an instruction pointer 243 and an instruction register 244. At the start of an instruction cycle, instruction decoder 241 puts the address in instruction pointer 243 on the address bus to the memory and receives from the memory the next instruction which is placed in instruction register 244. Instruction decoder 241 then proceeds to execute the instruction stored in instruction register 244. After or during execution of the instruction, adder 242 advances the address in instruction pointer 243. For example, the address in the instruction pointer is increased.

FIG. 3b shows an alternative embodiment of instruction cycle circuit 240, it is the same as FIG. 3a except that adder 242 is absent. Instead, the instruction cycle circuit of FIG. 3b comprises an addition look-up table 246 and a table based adder 247. The next address, instead of being computed, is looked up in table 246 by the table-based adder 247. In one embodiment addition look-up table 246 is a ROM having for each addressable memory location, the next location in storage. Other implementations break the addition up in multiple additions, each of which has a table. For example, the addition may be broken up into four byte wise addition, to perform a 32 bit addition. Carry may be handled as an additional input, thus obtaining a 9 bit output, two 8 bit inputs and 1 carry input. The instruction cycle circuit is thus configured to modify the program counter register by looking-up all or part of the address in the program counter register content

The advantage of table-driven instruction pointer advancement is improved security and resilience to power-out due to table-driven construction. However the disadvantage is loss of speed due to introduction of more computation cycles (e.g. fetch memory location, perform look up, feed back to register, etc.)

Neither processor 210 nor system 200 contains an ALU; nevertheless the computer system does support multiple arithmetic operations which may be executed under control of one or more of the instructions. The operations that are conventionally performed by the ALU are now performed by accessing one or more tables. The results from a table access are stored in registers, and then can be used in a next table access. The operations described by the tables may be complex, but as the tables are computed beforehand, this is not detrimental for the speed of operation.

Arithmetic and Logic operations may be performed by a processor 210 that mainly performs the following three operations:

Z:=X[Y], (to load the register)

X[Y]:=Z (to load the memory)

R:=Constant;

X, Y, Z and R denote registers. The square brackets denote indexed memory retrieval. Z:=X[Y] means that the value of the entry indexed by Y, in the table indexed by X, is written to a register Z, i.e., the data content of the memory location X+Y is transferred to register Z. Additionally, the processor may write to memory, and assign constants to registers. The processor comprises instructions, e.g. ‘opcodes’, to perform the above three operations.

Said constant may, e.g., be a base address, an index to base address, or an operand. In particular, the constant may be the base address of an instruction type table (O). The instruction type table storing the base address of multiple tables supporting arithmetic and/or logic functions.

In an embodiment, there are neither arithmetic operations (i.e., addition, subtraction, multiplication, division) nor logical operations (i.e., comparison with three conditions: Equal To, Greater Than, and Less Than, or any of these combinations) carried out in this processor by combinational logic. The memory can contain tables for these arithmetic and comparison operations. For unary operations a table with a single index suffices. For example, to implement a rotate operation on a register, e.g., the 8051 instruction RL—Rotate Accumulator Left. One may perform the table lookup X[Y], in which X contains the base address of a rotate table and Y is the register which is to be rotated 1 bit.

A function of two variables may be evaluated in two steps. If register Rt contains the base address of the table, we can compute the function of Ra and Rb by successively determining Rc=Rt[Ra] and Rc=Rc[Rb]. In other words, entry y of table Rt [Ra] equals (the base address for table function) f[Ra,y].

This procedure is simplified with a table O stored in memory. The table O contains the base address of all supported arithmetic and logic functions, such as plus, multiply, divide etc. Different instruction types stored in memory O can have different number of inputs and different number of outputs. For explanatory purposes, we consider an operation f in O, say f=O[i], with two inputs and a single output. We wish to obtain f(a,b), where the values of a and b are stored in registers Ra and Rb, and to store f(a,b) in register Rr. We then proceed as follows. First, we define Rt:=O[i]. Then we successively determine Rc=Rt[Ra] and Rc=Rc[Rb]. In other words, entry y of table O[i] [Ra] equals (the base address for table function) f[Ra,y].

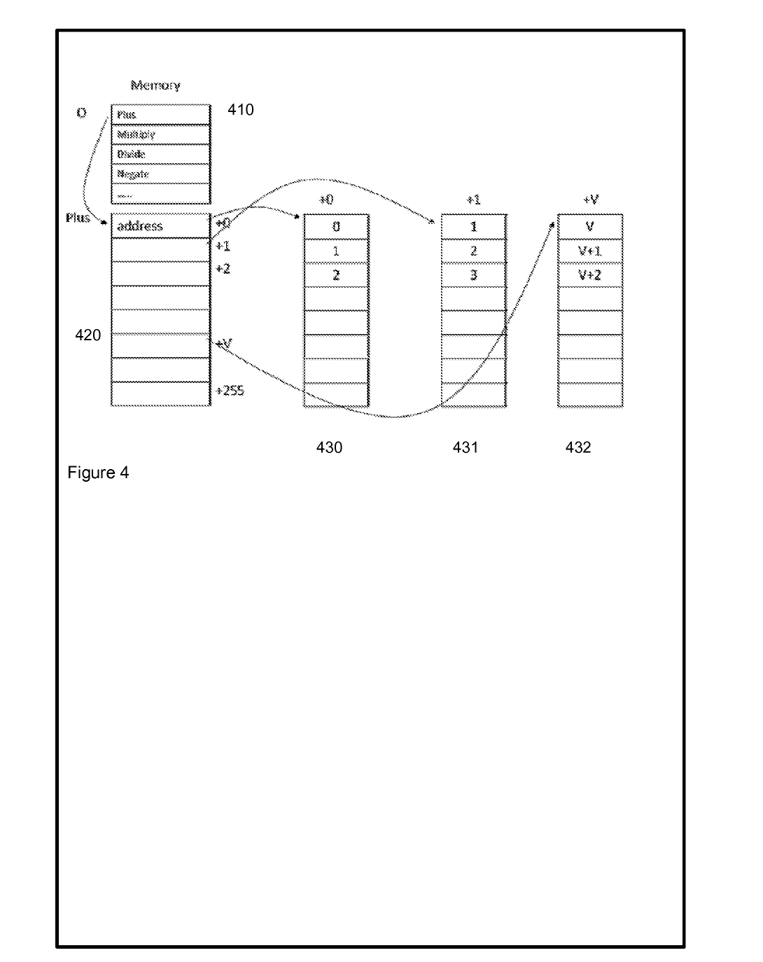

FIG. 4 visualizes the above with f equal to the “Plus” operation. FIG. 4 shows an instruction type table 410, i.e., ‘O’. Table 410 contains the address of an addition table 420. In table 420 the address are given for the functions +0 (430), +1 (431), etc, including +V (432). To compute 2+3, one looks up the ‘plus’ base address in table 410. Next in the addition table 420 the table for +3 is found. In the +3 table, entry number 2 (counting starting at 0) is the needed sum. The memory O can be optimized through the use of any set of addresses to locate various operations, not necessarily consecutive addresses.

A processor according to FIG. 2 may support several types of instructions. Examples are given below:

Processor 210 may support jumps both absolute and relative.

Processor 210 may support conditional jumps. Conditional jumps may be implemented with tables as well. The index of the table is the register upon which the conditional jump is to be taken. The table may give the absolute address to which to jump. For example, a 1 byte register may cause a conditional jump depending upon the value of the register. The conditional jump table may also give a relative address to jump to. The latter has the advantage that the table may be easily re-used for more jumps.

For example, processor may support a ‘jump if zero’, by having a table which has for index 0 a jump address, and for all non-zero entries a non-jump address. The jump address may be a positive value, or possibly, a negative value, the non-jump address may be +1, to point to the next instruction. These types of jumps may be supported by a special opcode that moves the content of a table entry to the instruction pointer, i.e., the contents of X[Y] wherein Y is a register and X may be a register or, optionally, a direct operand, to the instruction pointer.

Processor 210 may support move operations to and from memory, using indexed operations. For example, Processor 210 may support a move from X[Y] to a register Z, or vice versa.

Processor 210, may have a stack, and may support pop and push operations, e.g., of registers. Processor 210 may also support pushing and popping of the instruction register, to support subroutine calls.

Finally, processor 210 may support arithmetic and logic operations, e.g., add, add with carry, bitwise AND, subtract, subtract with carry, complement (negate), divide, bitwise OR, rotate, and the like. For these operations an explicit instruction may be used, the instruction may be then be translated to table lookup, e.g., using microcode. This allows ease of use. For example, the processor may explicitly support the 8051 instruction set, or similar, translating instructions to table look up as the program's instructions are executed. For example, processor 210 may comprise an ALU-to-table translator, for translating ALU opcodes to table look-up.

However, ALU opcodes, such as addition, bitwise AND, etc, may also be absent on processor 210. In this case the compiler produces code which directly implements these instructions as table lookup.

This processor can support any virtual machine. Instructions of such programs in the proposed processor-supported VM only manipulate registers, memory, but do not use an ALU—Arithmetic Logic Unit. Hence, we can construct a processor without needing to save the states of the ALU (CPU), and consequently we can construct an ALU-free VM based on this processor.

As described above, the instruction cycle circuit may comprise an instruction pointer and look-up tables for calculating advancement of the instruction pointer. This calculation method, which uses local look-up tables and microcode instructions implemented in the instruction cycle circuit, is similar to the processor instruction set and the look-up tables in memory for implementing addition calculations. It is possible to implement the instruction cycle circuit not as a separate circuit, but the instruction cycle circuit functionality can be implemented partly or in whole using the generic machine functionality. This simplifies the processor design and increases resilience against side-channel attacks and reverse engineering attacks.

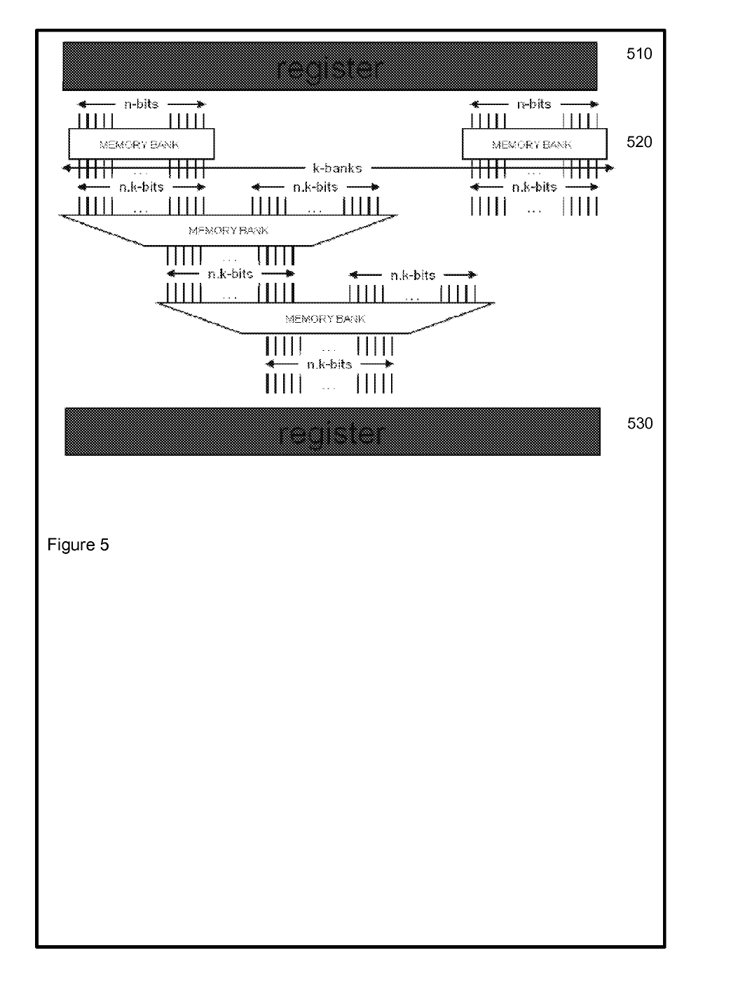

FIG. 5, 6 and 7 illustrates an execution of a computer program on processor 210. FIGS. 5, 6 and 7 are time diagrams, time flowing from top to down.

A computer program for the table driven processor 210, may be based on a network of tables constituting the semantics of a program. The program comprises a chain of independent memory accesses. The initial input for a program may be an address to the memory banks and the final output of a program may be the data stored in a memory bank or combinations thereof. Stages in between are both output from a memory bank, and input to a memory bank.

Software instructions may be implemented as one register-memory-register layer, as indicated in FIG. 5. Operands (e.g. X and Y) of the instruction are stored at memory banks, and arithmetic or logic operations may be performed using the tables stored in the memory.

FIG. 5 shows a Register-table-register layer implementation and does not use micro-programs, and each software instruction will be implemented using one register-memory-register layer.

The structure of processor 210 allows implementing programs that are presented as networks of tables. Note the tables (in memory) may have to be filled with information that contains parts of instructions.

Speed improvements are possible by pipelining of lookups. The simple processor as defined above requires relatively many table lookups for performing a function. If speed is of importance, pipelining of lookups may be employed.

In a table-driven implementation, the result of a table lookup is used as input to a next lookup table. As a result, every Register-table-register layer (corresponding to a single table lookup) can execute again as soon as the result is handed over to a next chain element. The transitions from one value in a register to another will be realized by a memory access. The processor pipelining can thus be characterised as a chain of table and registers where the first layer of register-table-register performs activities which can be contained within an access period of the memory (which holds the table), the second of register-table-register does the next part and so on. This gives natural timing and efficiency of tables.

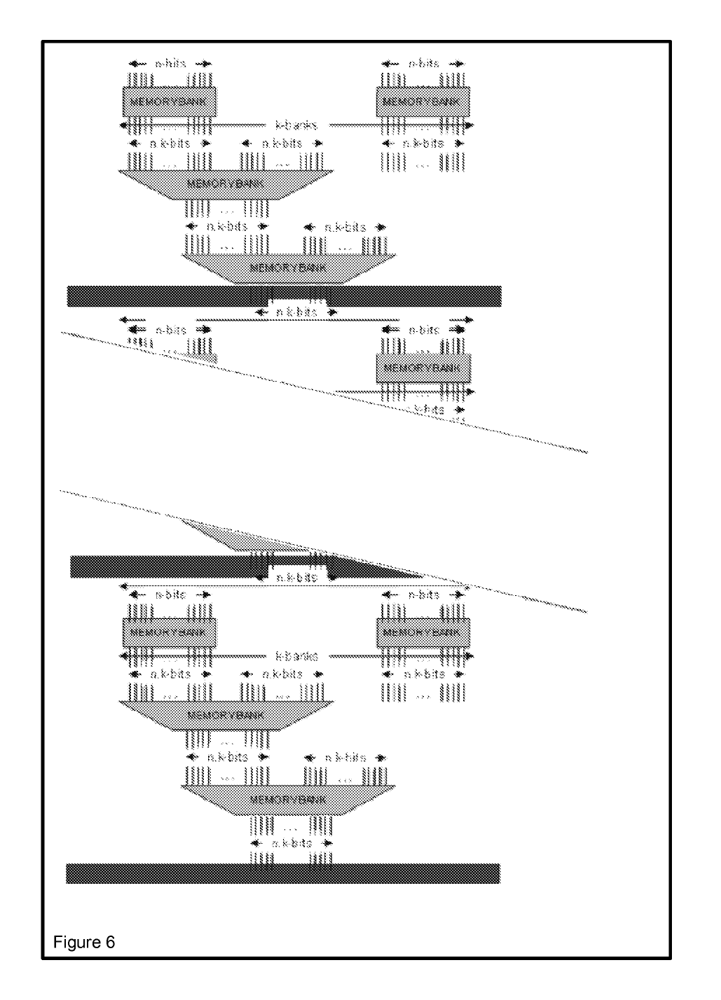

FIG. 6 shows a chain of access to finite instructions, with pipelining of registers-table-register layers. FIG. 6 can be seen as a cascade of register-table formations (i.e. iteration of hardware with tables) to implement a finite number of instructions, where each table-layer is the equivalent of what an instruction would do. It also explains how registers-table-registers can be chained (pipelined). Note that the registers are shared.

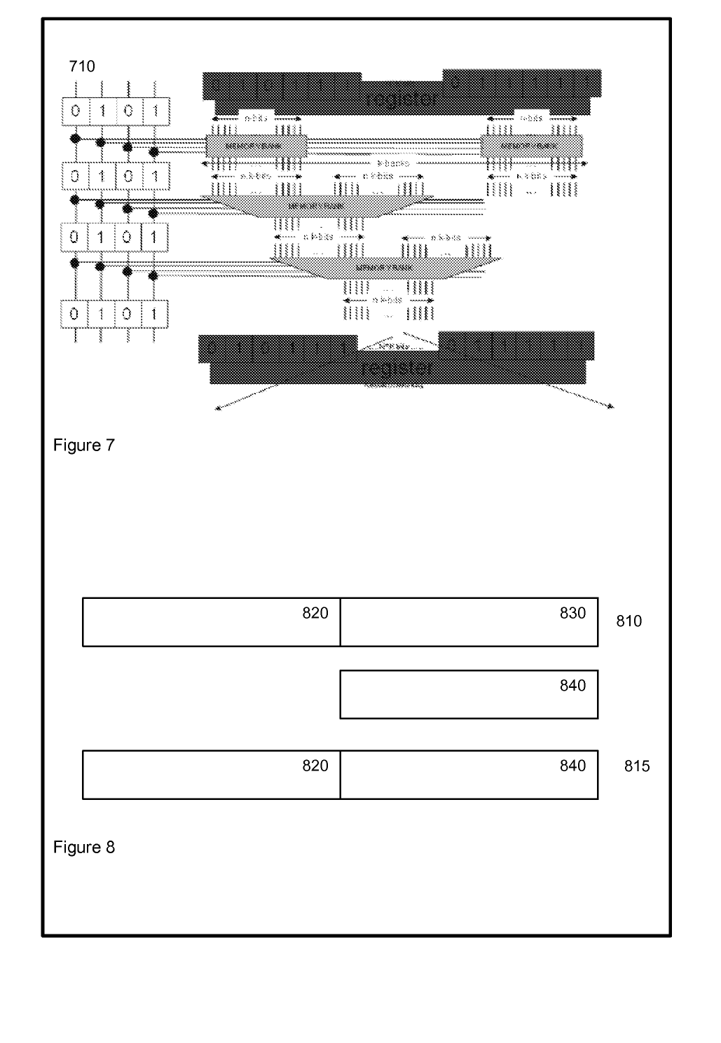

FIG. 7 shows a further refinement of FIG. 5 using a memory control register in processor 210, which is here shown as 4 bits, to control the memory bank in which a table look-up is done. In this way the operation that is performed may be controlled. The table can be selected by selecting an appropriate a bank of memory. The memory control register is a register, the content of which is combined, e.g., pre-pended, concatenated, etc, with the address on the internal bus, or as generated by the addressing calculating unit. For example, one memory bank may have addition tables, whereas another has bitwise AND tables. By selecting the appropriate memory bank using the memory control register, a choice can be made between two operations, i.e., addition and bitwise AND. FIG. 7 shows, as an example, under reference numeral 710 the content of the memory control register.

FIG. 8 shows powers-of-two indexing to simplify the ACU (Address Calculation Unit). A table driven-implementation, such as processor 210, does not comprise an ALU, but it may well comprise an ACU (address calculating unit). In such an ACU, one operation is the addition of the index address and the base address. A carry is often generated from the addition operation of index and the base address, and in this case, bits will be flipped from 0 to 1 or vice versa. Note that arrays are a typical choice to implement a table.

We can further optimize this, by eliminating the carry so that there will be no flipping of bits due to the carry. This improves energy consumption of our processor. Also a more constant behavior is obtained, thus minimizing information leakage through the power consumption side channel.

Carry is avoided by choosing the base address of a table as a multiple of a powers of two; no carry is generated, an addition only involves the concatenation of index and base address. To compute the address of M[index] one may compute 2^{k}*base+index. Here M=2^{k}*base. The addition may be computed by concatenating base and index. For this to work the largest index should be less than 2^{k}.

Shown in FIG. 8 is a base address 810 comprising a most significant part 820, and a least significant part 830. All the bits in least significant part 830 have value 0. Also shown is an index 840. If the array requires multiplication, i.e., because the array comprises elements which are larger than a single memory unit, e.g., larger than 1 byte, it is assumed that such a multiplication as already been performed in index 840. The size of 830 has been chosen so that is has at least as many bits as the largest used index 840. The address 815 where the table lookup is to be done is given by the sum of base address 810 and index 840. Because lsb 830 only has zero's, the sum can be computed by concatenating msb 820 and index 840.

This optimization of addressing calculation operation can be defined in the program directly.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### LIST OF REFERENCE NUMERALS

100 a computer system
110 an internal bus
120 an ALU
122, 124 an ALU input
126 an ALU control signal
128 an ALU output
130 computer processor circuitry
140 a memory
200 a computer system
210 a computer processor
220 an internal bus
230 a data and address bus interface
235 a data and address bus
240 an instruction cycle circuit
241 an instruction decoder
242 an adder
243 an instruction pointer
244 an instruction register
246 an addition look-up table
247 an table-based adder
245 a register file
250 a memory
255 a memory mapped I/O interface
260 a control bus

1. A computer system comprising a processor and a memory,
the processor comprising
an instruction cycle circuit configured to repeatedly obtain a next instruction of a computer program,
an instruction decoder configured to decode and execute the instruction obtained by the instruction cycle circuit,
the computer system supporting multiple arithmetic and/or logic operations under control of one or more of the instructions, wherein
the memory stores multiple tables, each specific one of the multiple arithmetic and/or logic operations being supported by at least one specific table stored in the memory that represents at least part of the result of the specific arithmetic operations for a range of inputs
wherein the memory stores the computer program,
the instruction cycle circuit comprises a program counter register, the instruction cycle circuit is configured to obtain the next instruction under control of a program counter register, the instruction cycle circuit comprising a program counter register advancer configured to advance the program counter register so that the program counter register controls the obtaining of a next instruction,
wherein the instruction cycle circuit comprises a further memory and a table-based adder, the further memory storing an addition table, the instruction cycle circuit being configured to modify the program register by looking-up in the addition table by the table-based adder.

2. (canceled)

3. A computer system as in claim 1, wherein the processor comprises a table translator, the table translator is configured to receive arithmetic and/or logic instruction from an instruction register and to produce corresponding table look-up operations.

4. A computer system as in claim 1, wherein the computer system has a stand-by device configured to save the content of registers of the processor, including instruction pointer register.

5. A computer system as in claim 1, wherein the computer system has an address calculation unit for computing the address of an entry in a table from a base address and an index, wherein the address calculation unit concatenates the base address and the index.

6. A computer system as in claim 1, wherein an arithmetic and/or logic operations is supported by
retrieving the base address of the tables supporting said arithmetic and/or logic operation,
adding to the base address an index obtained from a first operand to said arithmetic and/or logic operation,
retrieving from the added base address a result or a further table address.

7. A computer system as in claim 1, wherein the memory comprises an instruction type table (O), the instruction type table storing the base address of tables supporting the arithmetic and logic functions.

8. A computer system as in claim 1, herein the multiple arithmetic and/or logic operations are exclusively supported by the multiple tables

9. A computer system as in claim 1, wherein the computer processor comprises at least two registers, the computer system supporting at least an addition operation for adding the content of the two registers and an AND operation for bitwise AND-ing the content of the two registers, wherein the memory contains an addition table and an AND-table.

10. A computer system as in claim 1, wherein the computer system does not comprise a combination logic circuit receiving a first and second operand from an internal bus of the processor and producing an output to the internal bus calculated from the first and second operand.

11. A computer system as in claim 1, wherein the instruction decoder is configured for jumps conditional on a conditional value by,
retrieving a data item representing an address from a table at a location in the table corresponding to the conditional value,
writing the address to an instruction pointer.

12. A computer processor as in claim 1.

13. A compiler configured to compile a computer program in a first computer language for a computer system as in claim 1.

14. A compiler as in claim 13 configured to compile any arithmetic or logic operation in table look-up operations.

15. A compiler as in claim 13 configured to compile look-up tables storing the result of an arithmetic or logic operations for a range of input values.

16. A computer system as in claim 1, wherein the instruction cycle circuit is configured to modify the program counter register to the entry of said addition table indexed by the address in the program counter register content.
